(19) United States
(12) Patent Application Publication
(10) Pub. No.: US 2004/0192412 A1
(43) Pub. Date: Sep. 30, 2004

(54) Cellular phone

(75) Inventors: Tomoaki Ono, Hitachi (JP); Shinya Yamamoto, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/306,100

(22) Filed: Nov. 27, 2002

(30) Foreign Application Priority Data
Mar. 14, 2002 (JP) 2002-070413

(51) Int. Cl. H04B 1/38

(52) U.S. Cl. 455/574; 455/566; 455/550.1

(57) ABSTRACT

An object of the present invention is to reduce power consumption during a wait state to thereby extend battery life in a cellular phone having at least two processors, a processor for telephone functions that processes telephone functions, and a processor for application functions that processes application functions. To achieve this object, a cellular phone of the present invention includes a display part, a processor for telephone functions that processes telephone functions, a processor for application functions that processes applications, and a switching circuit that switches the suppliers of a control signal to the display part, wherein the switching circuit performs switching so that a control signal from the processor for telephone functions is supplied to the display part during a wait state, and a control signal from the processor for application functions is supplied to the display part during application processing.

### BACKGROUND OF THE INVENTION

1. Field of the Invention

The present invention relates to a cellular phone, and more particularly to a technique relating to power saving in a cellular phone having at least two processors, that is, a processor for processing telephone functions, and a processor for processing application functions.

2. Description of the Prior Art

In recent years, cellular phones have become able to browse various contents by means of a browser or the like, or use down-loaded contents (hereinafter referred to as applications) An increasing number of cellular phones have had telephone functions for performing operations on the phones and application functions such as the reproduction of moving pictures and music, and execution of down-loaded games on the cellular phones, receiving attention of the market. Such cellular phones having application functions require fast processing performance to obtain excellent display comfortability and operability. As a technique for achieving the fast processing, a common method is to use a processor (CPU: Central Processing Unit) for processing functions the operating clock frequency of which is increased to enable fast processing.

Although cellular phones of prior arts have processed telephone functions and application functions by one processor, to cope with diversified application functions, the amount of data to be processed has become so large that heavy processing loads have been imposed on the one processor to an uncotrollable extent. As a result, a technique has been adopted that processes telephone functions and application functions by different processors. Having two processors has the advantage of being capable of processing the telephone functions and the application functions at the same time.

### SUMMARY OF THE INVENTION

It is important that a secondary battery powering a cellular phone has a long operating life, and accordingly it is necessary to reduce power consumption. For this reason, the operation of circuit blocks that do not need to operate is stopped or saved, reducing power consumption. For example, a display light is turned off during a wait state. On the other hand, although processors having fast processing performance tend to be used to comfortably use various applications, the processor to fast perform processing has the problem that power consumption increases.

However, in the prior art, there has been a problem in that no consideration is given to reducing power consumption by controlling the operation of a processor for application functions during a wait state. Therefore, there has been a problem in that power consumption during the wait state cannot be reduced and the operating life of a battery becomes short. Particularly, it has been a large problem in terms of battery life that the processor for application functions requiring high power consumption cannot, during the wait state, be placed into standby mode (so-called power save mode, sleep mode, etc.) in which power consumption becomes low. Moreover, there has been a problem in that, for a fold-down cellular phone having a main display part for displaying images and a secondary display part for displaying information of telephone functions, no consideration is given to the control of the secondary display part. That is, there has been a problem in that, in the case where the display of the secondary display part is controlled by the processor for application functions, the processor for application functions cannot be placed into the standby mode during the wait state, so that reduction in power consumption cannot be achieved.

Another problem has been that, for a fold-down cellular phone, no consideration is given to placing a processor for application functions into the standby mode when the cellular phone is folded down, so that reduction in power consumption cannot be achieved. That is, when the cellular phone is folded down, since the main display part displaying an application such as game is hidden from view and the user cannot view application functions such as game, the application is stopped and the cellular phone is placed into a wait state. However, there has been a problem in that, since the processor for application functions is not shifted to the standby mode at this time, power consumption cannot be reduced.

Technical problems to be solved by the present invention are to solve the above described problems of the prior art, and an object of the present invention is to reduce power consumption during the wait state and thereby extend battery life in a cellular phone having at least two processors, a processor for telephone functions that processes telephone functions, and a processor for application functions that processes application functions.

To achieve the above described object, a cellular phone of the present invention includes a display part, a processor for telephone functions that processes telephone functions, a processor for application functions that processes applications, and a switching circuit that switches the suppliers of a control signal to the display part, wherein the switching circuit performs switching so that a control signal from the processor for telephone functions is supplied to the display part during a wait state, and a control signal from the processor for application functions is supplied to the display part during application processing. With this construction, a control signal to the display part can be supplied from the processor for telephone functions during the wait state.

Preferably, the processor for application functions has application processing mode and standby mode, and controls the switching circuit so that, during the standby mode, the supplier of a control signal to the display part is the processor for telephone functions. With this construction, the processor for application functions can be placed into the standby mode requiring low power consumption during the wait state to save power consumption.

Preferably, the display part includes a main display part and a secondary display part, and a control signal to the main display part is switched by the switching circuit. With this construction, a control signal to the main display part can be supplied from the processor for telephone functions during the wait state, so that power consumption can be saved.

Preferably, the display part includes a main display part and a secondary display part, and the secondary display part is controlled by the processor for telephone functions to display telephone status. With this construction, a display signal is supplied to the secondary display part from the processor for telephone functions requiring low power consumption, and the secondary display part can display information on telephone functions independently of the operation of the processor for application functions, so that power consumption can be saved.

Preferably, the cellular phone has a fold-down structure with two enclosures engaged by a hinge, is provided with a detecting circuit for detecting that the cellular phone is folded down, and goes to a wait state when it is detected by the detecting circuit that the cellular phone is folded down. With this construction, since the cellular phone automatically goes to the wait state when it is folded down, the processor for application functions can be placed into the standby mode to save power consumption.

To achieve the above described object, the cellular phone of the present invention is a fold-down cellular phone with two enclosures engaged by a hinge that includes a display part, a processor for telephone functions that processes telephone functions, a processor for application functions that processes applications, and a detecting circuit for detecting that it is folded down, wherein said processor for application functions has application processing mode and standby mode, and when it is detected by the detecting circuit that the cellular phone is folded down, the processor for application functions goes to the standby mode. With this construction, when the cellular phone is folded down, the processor for application functions can be placed into the standby mode requiring low power consumption during the wait state to save power consumption.

As has been described, the present invention is a cellular phone having at least two processors, a processor for telephone functions that processes telephone functions, and a processor for application functions that processes application functions, wherein a switching circuit for switching a control signal to a display part is provided, and during the wait state, a control signal from the processor for telephone functions is supplied to the display part, and at the same time, the processor for application functions is placed into the standby mode, whereby power consumption during the wait state can be saved and battery life can be extended.

### BRIEF DESCRIPTION OF THE DRAWINGS

Preferred embodiments of the present invention will be described in detail based on the followings, wherein:

FIG. 1 is a block diagram showing a configuration of a cellular phone according to a first embodiment of the present invention;

FIG. 2 is a block diagram showing a switching means for control signals to a main display unit in the first embodiment of the present invention;

FIG. 3 is a block diagram showing a switching means for control signals to an audio function part in the first embodiment of the present invention;

FIG. 4 is a flowchart showing an example of processing operation in the first embodiment of the present invention;

FIG. 5 is a block diagram showing a configuration of a cellular phone according to a second embodiment of the present invention; and

FIG. 6 is a flowchart showing an example of processing operation in the second embodiment of the present invention;

### DESCRIPTION OF THE PREFERRED EMBODIMENTS

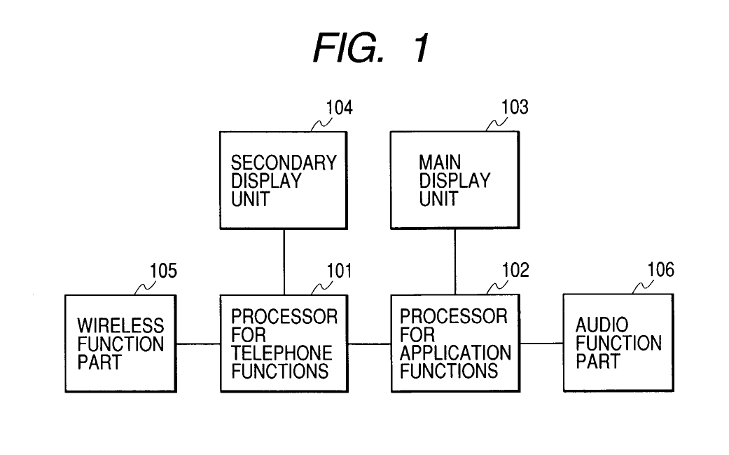

A first embodiment of the present invention is described using FIGS. 1 to 4. FIG. 1 is a block diagram showing a configuration of a cellular phone according to a first embodiment of the present invention. In FIG. 1, the reference number 101 designates a processor for telephone functions; 102, a processor for application functions that performs processing on applications; 103, a main display unit for primarily making display related to applications such as moving pictures; 104, a secondary display unit for primarily making display related to telephone functions; 105, a wireless function part for performing wireless communications with a base station; and 106, an audio function part for pronouncing a call arrival sound and sound data of moving pictures.

In this embodiment, in a wait state (that is, a wait state of an entire cellular phone) in which communications or application execution is not performed as the cellular phone, both the processor 101 for telephone functions and the processor 102 for application functions take standby mode to reduce power consumption. However, the processor 101 for telephone functions are periodically activated to check the condition of radio waves and other conditions even during the wait state, and performs communications with a base station through the wireless function part 105 to display the conditions on the secondary display unit 104. The above described state of standby mode for reducing power consumption refers to a function referred to as power save mode or sleep mode that controls processing within a processor to reduce power consumption. For example, the technique of stopping or limiting the operation of processing blocks not used, the technique of reducing an operation clock to slow down processing, and other techniques are used to reduce the power consumption of a processor. It goes without saying that techniques for reducing the power consumption of a processor are not limited to the above described techniques. During communication, only the processor 101 for telephone functions is activated to perform the same processing as described above. When an application is being executed, both the processor 101 for telephone functions and the processor 102 for application functions are activated to perform the control of display to the secondary display unit 104 and the main display unit 103, the control of sounds to the audio function part 106, and necessary control of blocks not shown. By this arrangement, during the wait state, the processor 101 for telephone functions is activated only occasionally, resulting in reduction in power consumption.

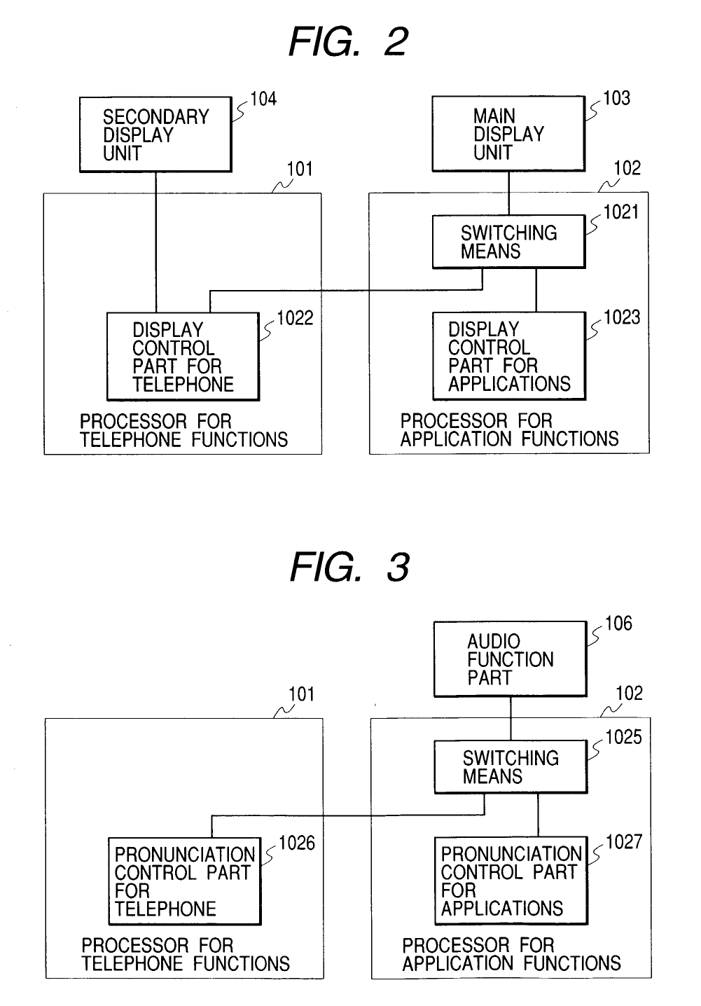

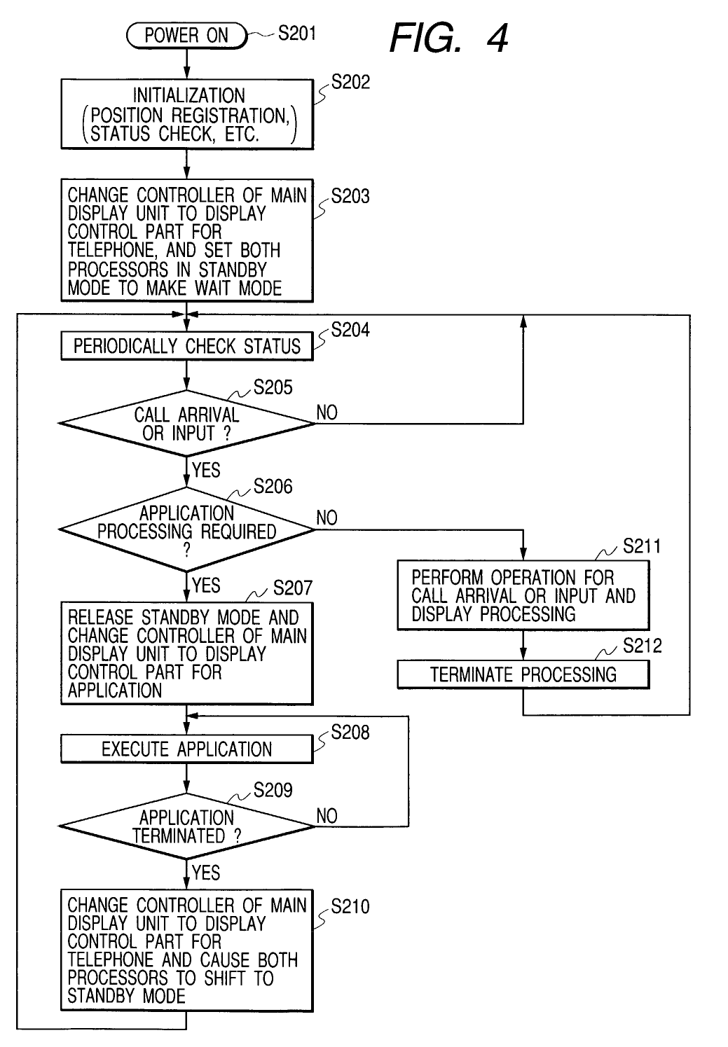

Next, referring to FIGS. 2 and 3, a switching means for control signals is described in detail. FIG. 2 is a block diagram showing a switching means for switching a display control signal to the main display unit 103. In FIG. 2, the reference number 1021 designates a switching means for switching a display control signal to the main display unit 103; 1022, a display control part for telephone that produces a display control signal within the processor 101 for telephone functions; and 1023, a display control part for application that produces a display control signal within the processor 202 for application functions.

During the wait state, as described previously, both the processor 101 for telephone functions and the processor 102 for application functions take standby mode to reduce power consumption. However, the processor 101 for telephone functions is periodically activated to check the condition of radio waves and other conditions even during the wait state, performs communications with a base station to check conditions through the wireless function part 105, and displays information about required communication functions at least on the secondary display unit 104 under control of the display control part 1022 for telephone.

The processor 102 for application functions has two modes, standby mode and application processing mode. During the standby mode, control signals from the display control part 1022 for telephone (the processor 101 for telephone functions) are outputted from the switching means 1021 to the main display unit 103 so that information on telephone functions such as the condition of radio waves can be displayed on the main display unit 103. During the application processing mode, the processor 102 for application functions outputs control signals from the display control part 1023 for application and they are outputted from the switching means 1021 to the main display unit 103 so that information on the application is displayed on the main display unit 103.

As described above, the switching means 1021 switches the suppliers of a display control signal to the main display unit 103 between during the wait state and during application execution, and the switching control of the switching means 1021 is performed by the processor 102 for application functions.

Herein, further details will be are given. To display information regarding telephone functions on the secondary display unit 104 (and the main display unit 103 as required) during the wait state requires processing power of about 1 MIPS (mega instructions per second). To display images and the like regarding an application on the main display unit 103 during application execution requires processing power of about 100 MIPS. Thus, processing power required for the display units greatly differ for display processing during execution of telephone functions and display processing during application execution. Processing power of about 1 MIPS can be achieved by the processor 101 for telephone functions, which has relatively low processing power. For this reason, in cases where application processing is required, the processor 102 for application functions is activated so that the main display unit 103 is made to perform display by control signals from the display control part for application, while, during the wait state, the main display unit 103 is controlled by control signals from the display control part 1022 for telephone within the processor 101 for telephone functions and the processor 102 for application functions is placed into standby mode. By this arrangement, power consumption can be reduced.

FIG. 3 is a block diagram showing a configuration of a switching means for switching an audio control signal to the audio function part 106. In FIG. 3, the reference number 1025 designates a switching means for switching an audio control signal to the audio function part 106; 1026, a pronunciation control part for telephone that produces an audio control signal within the processor 101 for telephone functions; and 1027, a pronunciation control part for applications that produces an audio control signal within the processor 102 for application functions.

When both the processors 101 and 102 are in standby mode (the wait state of the cellular phones), control signals from the pronunciation control part 1026 for telephone (the processor 101 for telephone functions) are outputted from the switching means 1025, whereby the audio function part 106 can produce sounds on telephone functions such a call arrival sound. During the application processing mode, control signals from the pronunciation control part 1027 for application (the processor 102 for application functions) are outputted from the switching means 1025, whereby the audio function part 106 can produce sounds on applications.

As described above, the switching means 1025 switches the suppliers of an audio control signal to the main display unit 103 between during the wait state and during application execution, and the switching control of the switching means 1021 is performed by the processor 102 for application functions.

Therefore, when telephone functions typified by a call arrival sound are activated, with the processor 102 for application functions kept in the standby mode, a call arrival sound can be issued from the audio function part 106 by a control signal from the pronunciation control part 1026 for telephone As a result, power consumption can be reduced.

Although, in the above example, the switching means 1021 and 1025 are provided within the processor 102 for application functions, similar switching means may be externally provided.

Although, in the above example, the switching means 1021 and 1025 perform switching according to a switching control signal outputted from the processor 102 for application functions, it goes without saying that they may perform switching according to a switching control signal from the processor 101 for telephone functions or they may perform switching according to a switching control signal from one of the processor 102 for application functions and the processor 101 for telephone functions, depending on a situation at that time.

Although, in the above example, the processor 102 for application functions switches the switching means 1021 and 1025 to an output selection side of the processor 101 for telephone functions by a control signal during the standby mode, the switching may be made upon transition to the wait state.

Next, a flow of processing for switching a display control signal to the main display unit 103 is described using FIG. 4. FIG. 4 is a flowchart showing processing for switching the control sources of a display control signal to the main display unit 103.

Power to the cellular phone is turned on (step S201). In step S202, power is supplied to required circuit blocks including the processor 101 for telephone functions and the processor 102 for application functions, required processing is started, and initialization such as position registration and condition checking is performed. In step S203, the controller of a display control signal to the main display unit 103 is changed to the display control part 1022 for telephone, and the processor 101 for telephone functions and the processor 102 for application functions are set in the standby mode to place the cellular phone into the wait state.

For the duration of the wait state, in step S204, the processor 101 for telephone functions is activated every predetermined time to perform communications with the base station through the wireless function part 105 and display conditions on the secondary display unit and/or main display unit 103. In step S205, a telephone function such as call arrival or user input through an input means (not shown) is monitored, and if there is no call arrival or user input, control returns to step S204.

If there is call arrival or user input in step S204, in step S206, whether application processing is required is judged by the processor 101 for telephone functions. If it is judged in step S206 that application processing is required, control goes to step S207, and otherwise control goes to step S211.

In step S207, the processor 101 for telephone functions releases the standby mode of the processor 102 for application functions and changes the supplier of the display control signal to the main display unit 103 to the display control part 1023 for application (or the processor 102 for application functions that has shifted to the application processing mode changes the supplier of the display control signal to the main display unit 103 to the display control part 1023 for application). Thereby, the processor 102 for application functions, in step S208, performs application processing and makes a display corresponding to the application on the main display unit 103. In the next step S209, it is judged whether the application processing has terminated, and if not so, control returns to step S208 to continue the application processing. When it is judged in step S209 that the application processing has terminated, control returns to step S210, where the processor 102 for application functions changes the supplier of the display control signal to the main display unit 103 to the display control part 1022 for telephone, and the processor 101 for telephone functions and the processor 102 for application functions are shifted to the standby mode to place the cellular phone into the wait state. Then, control returns to step S204 to periodically check conditions, and call arrival or input is awaited in step S205.

If it is judged in step S206 that application processing is not required, in step S211, a telephone function operation as typified by call arrival or an operation other than application processing, based on an input operation, and corresponding display processing are performed. If the processing terminates in step S212, control returns to step S204 to periodically check conditions, and call arrival or input is awaited in step S205.

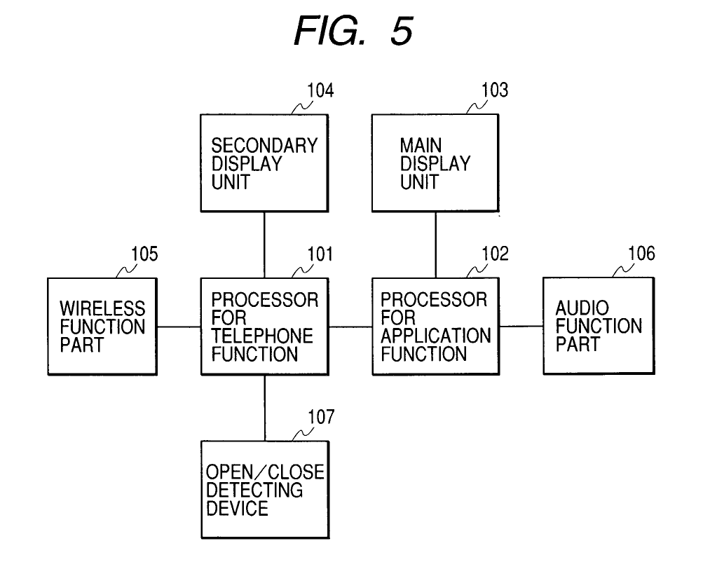

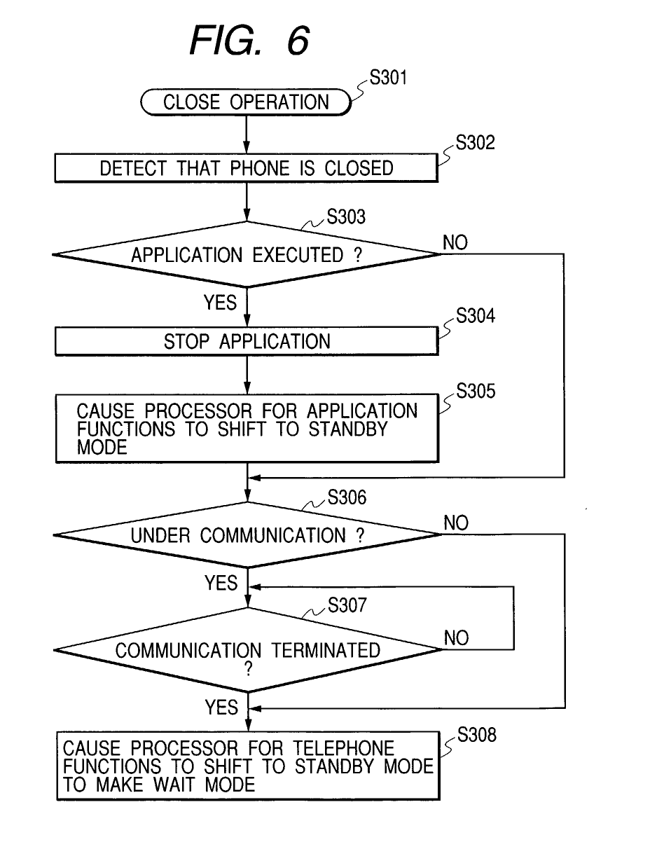

Next, a second embodiment of the present invention is described using FIGS. 5 and 6. FIG. 5 is a block diagram showing a configuration of a cellular phone according to a second embodiment of the present invention. It is understood that components shown in FIG. 5 that are identical to components shown in the first embodiment of FIG. 1 are identified by the same reference numbers and descriptions of them are omitted to avoid duplication. The internal structures of the processor 101 for telephone functions and the processor 102 for application functions are the same as those in FIGS. 2 and 3.

This embodiment is an example of application to a fold-down cellular phone that consists of two enclosures engaged by a hinge. In FIG. 5, the reference number 107 designates an open/close detecting device for detecting whether the fold-down cellular phone is folded down.

In this embodiment, when the open/close detecting device 107 detects that the fold-down cellular phone has been closed (folded down) by the user during execution of application processing, the processor 101 for telephone functions detects that the cellular phone has been closed, and notifies the processor 102 for application functions of the fact. In response to this notification, the processor 102 for application functions stops application processing in execution and shifts to the standby mode. The processor 101 for telephone functions is also put in the standby mode to place the cellular phone into the wait state. By this arrangement, the user has only to close the fold-down cellular phone to place the cellular phone into the wait state without having to perform operations for terminating an application, leading to an increase in usability.

Instead of stopping the application processing in execution, the termination of the application processing may be awaited before transition to the standby mode. As a condition for transition to the standby mode, whether to stop or terminate the application processing may be selected by the user.

Or, when it is detected that the fold-down cellular phone has been folded down, the following may also be performed. It is judged whether an application in execution involves a display to the main display unit 103 or makes no display to the main display unit 103 (or does not necessarily require a display to the main display unit 103), and if the application in execution involves a display to the main display unit 103, the application processing is stopped and the processor 102 for application functions and the processor 101 for telephone functions are put in the standby mode to place the cellular phone into the wait state.

Although, in the above example, the output of the open/close detecting device 107 is sent to the processor 101 for telephone functions, it may be sent to the processor 102 for application functions.

FIG. 6 is a flowchart showing the flow of processing for placing the processor 102 for application functions into the standby mode when the cellular phone has been folded down.

When the fold-down cellular phone is closed (step S301) in step S302, the fact is detected by the open/close detecting device 107 (step S302). In step S303, when application processing is currently being executed by the processor 102 for application functions is judged by the processor 101 for telephone functions or the processor 102 for application functions. If application processing is in execution, it is stopped in step S304, and then control proceeds to step S305. If application processing is not in execution, control immediately proceeds to step 306.

In step S305, the processor 102 for application functions shifts to the standby mode and control proceeds to step S306. It is judged in step S306 whether the processor 101 for telephone functions are in communication, and if so, the communication is continued until it terminates. On the other hand, if it is judged in step S306 that communication is not in progress, or it is judged in step S307 that communication terminates, control proceeds to step S308. In step S308, the processor 101 for telephone functions shifts to the standby mode to go into the wait state, and waits for a next telephone function as typified by call arrival or user input through an input means (not shown).

Although, in the above example, application execution status is judged in the step S303 and communication execution status is judged in the step S306, the judgment processing may be bypassed to go to the step S304 or S307. When communication is in progress, although it is awaited in step S307 that the communication terminates, the communication may be stopped to go to the step S308.

Although the switching of a display control signal and the switching of an audio control signal are separately described in the above embodiments, it goes without saying that the present invention may apply to both the switchings.

Although the application of the present invention to ordinary cellular phones is described in the above embodiments, it goes without saying that the present invention can apply to PDA and other portable communication terminals having cellular phone functions (an antenna, circuits, a transmitter, a receiver, a display, and the like for cellular phone communications) if they have a processor for telephone functions and a processor for application functions. The cellular phones referred to in the present invention include portable communication terminals having these cellular phone functions.

As has been described above, according to the present invention, there is provided a cellular phone having at least two processors, a processor for telephone functions that processes telephone functions, and a processor for application functions that processes application functions, wherein a switching means for switching a control signal to a display part is provided so that a control signal from the processor for telephone functions is supplied to the display part by the switching means during a wait state and at the same time the processor for application functions is placed into standby mode, thereby reducing power consumption during the wait state and extending battery life.

1. A cellular phone including a display part, a processor for telephone functions that processes telephone functions, a processor for application functions that processes applications, and a switching circuit that switches the suppliers of a control signal to said display part, wherein:
said switching circuit performs switching so that a control signal from said processor for telephone functions is supplied to said display part during await state, and a control signal from said processor for application functions is supplied to said display part during application processing; and
said processor for application functions has application processing mode and standby mode, and controls said switching circuit so that, during said standby mode, the supplier of a control signal to said display part is said processor for telephone functions.

2. The cellular phone according to claim 1,
wherein said display part includes a main display part and a secondary display part, and a control signal to said main display part is switched by said switching circuit.

3. A cellular phone including a display part, a processor for telephone functions that processes telephone functions, a processor for application functions that processes applications, and a switching circuit that switches the suppliers of a control signal to said display part, wherein:
said switching circuit performs switching so that a control signal from said processor for telephone functions is supplied to said display part during a wait state, and a control signal from said processor for application functions is supplied to said display part during application processing; and
said display part includes a main display part and a secondary display part, and said secondary display part is controlled by said processor for telephone functions.

4. The cellular phone according to claim 1,
wherein the cellular phone has a fold-down structure with two enclosures engaged by a hinge, is provided with a detecting circuit for detecting that the cellular phone is folded down, and goes to a wait state when it is detected by the detecting circuit that the cellular phone is folded down.

5. The cellular phone according to claim 3,
wherein the cellular phone has a fold-down structure with two enclosures engaged by a hinge, is provided with a detecting circuit for detecting that the cellular phone is folded down, and goes to a wait state when it is detected by the detecting circuit that the cellular phone is folded down.

6. A fold-down cellular phone with two enclosures engaged by a hinge, including a display part, a processor for telephone functions that processes telephone functions, a processor for application functions that processes applications, and a detecting circuit for detecting that it is folded down,
wherein said processor for application functions has application processing mode and standby mode, and when it is detected by said detecting circuit that the cellular phone is folded down, said processor for application functions goes to said standby mode.
